(19) United States
(12) Patent Application Publication
(10) Pub. No.: US 2021/0282896 A1
(43) Pub. Date: Sep. 16, 2021

(54) EXTRACTION DEVICE AND ASSOCIATED SYSTEM AND METHOD

(71) Applicant: Michael Faykin, Huntingdon Valley, PA (US)

(72) Inventor: Michael Faykin, Huntingdon Valley, PA (US)

(21) Appl. No.: 16/816,338

(22) Filed: Mar. 12, 2020

(51) Int. Cl. A61C 3/14; A61G 15/14

(52) U.S. Cl. CPC A61C 3/14; A61G 15/14

(57) ABSTRACT

An extraction device is provided. The extraction device includes a first body half including a first handle with an outer surface and an inner surface, and a second body half hingedly coupled to the first body half. The second body half includes a second handle with an outer surface and an inner surface. The outer surface of the first handle faces away from the outer surface of the second handle, and the inner surfaces of the first and second handles face each other. The extraction device includes an anchor extending from the outer surface of the first handle or formed in the first handle.

### BACKGROUND

In general, some traditional tooth extraction devices are used by placing one end of the tool around the tooth to be extracted, and placing a support section of the tool against an adjacent healthy tooth to create a pivot point for extraction of the tooth. After the tool has been positioned in the desired location, the dentist uses the tool as a fulcrum by pivoting the tool at the pivot point located at the healthy tooth. Such pivoting generates an upward pulling force on the tooth for extraction of the tooth. However, using a healthy tooth as the pivot point for the tool creates potential for damage to the healthy tooth during the extraction procedure.

### SUMMARY

In accordance with some embodiments of the present disclosure, an exemplary extraction device is provided. The extraction device discussed herein can be used for extraction of, e.g., a tooth, a crown, a post, combinations thereof, or the like. The extraction device includes a first body half including a first handle with an outer surface and an inner surface, and a second body half hingedly coupled to the first body half. The second body half includes a second handle with an outer surface and an inner surface. The outer surface of the first handle faces away from the outer surface of the second handle, and the inner surfaces of the first and second handles faces each other. The extraction device includes an anchor (e.g., one or more anchors) extending from the outer surface of the first handle or formed in the first handle.

The first body half includes a first curved extension extending at an angle from a proximal end of the first body half. The first curved extension can form a first half of a beak section of the extraction device. The second body half includes a second curved extension extending at an angle from a proximal end of the second body half. The second curved extension can form a second half of the beak section of the extraction device.

The first and second body halves include proximal and distal ends. The first and second body halves can be hingedly coupled together at or near the proximal ends. The anchor is configured to engage with a corresponding anchor of a fixation assembly coupled to a support structure (e.g., a ceiling, a wall, a post, a floor, or the like). Engagement between the anchor of the extraction device and the corresponding anchor of the fixation assembly create a pivot point at the anchor of the extraction device.

In some embodiments, the anchor can define a hook configuration extending from the outer surface of the first handle. In some embodiments, the anchor can include three anchors each defining the hook configuration and spaced relative to each other along the outer surface of the first handle. In some embodiments, the anchor can define a loop configuration extending from the outer surface of the first handle. In some embodiments, the anchor can define a hole formed in the first handle and extending transversely relative to sides of the first handle.

In accordance with embodiments of the present disclosure, an exemplary extraction system is provided. The extraction system includes an extraction device including a first body half including a first handle with an outer surface and an inner surface, and a second body half hingedly coupled to the first body half. The second body half includes a second handle with an outer surface and an inner surface, the outer surface of the first handle facing away from the outer surface of the second handle. The inner surfaces of the first and second handles face each other. The extraction device includes an anchor extending from the outer surface of the first handle or formed in the first handle. The extraction system includes a fixation assembly including a proximal end and a distal end. The proximal end of the fixation assembly is configured to be engaged with the anchor of the extraction device to allow for pivoting of the extraction device.

The distal end of the fixation assembly is configured to be coupled to a support structure. In some embodiments, the support structure can be at least one of a ceiling, a wall, a floor, or a post. After engagement of the proximal end of the fixation assembly with the anchor of the extraction device, the extraction device can be suspended from the support structure by the fixation assembly.

The fixation assembly includes an anchor at the proximal end. The anchor of the fixation assembly is configured to be detachably engaged with the anchor of the extraction device. Engagement between the anchor of the fixation assembly and the anchor of the extraction device forms a pivot point about which the extraction device is capable of pivoting. In some embodiments, the anchor of the fixation assembly can be at least one of a loop, a spring-loaded clip, a hook, or the like. In some embodiments, the fixation assembly can include a length adjustment mechanism selectively controllable to adjust a length of the fixation element.

In accordance with embodiments of the present disclosure, an exemplary method of extraction is provided. The method includes engaging an extraction device with a fixation assembly coupled to a support structure. The extraction device includes a first body half including a first handle with an outer surface and an inner surface, and a second body half hingedly coupled to the first body half. The second body half includes a second handle with an outer surface and an inner surface, the outer surface of the first handle facing away from the outer surface of the second handle. The inner surfaces of the first and second handles face each other. The extraction device includes an anchor extending from the outer surface of the first handle or formed in the first handle. The method includes gripping at least a portion of a structure to be extracted with the extraction device (e.g., a tooth, a crown, a post, or the like). The method includes pivoting the extraction device at a point of engagement with the fixation assembly to create a force for extracting the structure.

In some embodiments, the support structure can be at least one of a ceiling, a wall, a floor, or a post. Engaging the extraction device with the fixation assembly can include engaging an anchor of the fixation assembly with the anchor of the extraction device to suspend the extraction device from the fixation assembly.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed extraction device, reference is made to the accompanying figures, wherein:

FIG. 1 is a side diagrammatic view of an exemplary extraction system of the present disclosure including an extraction device;

FIG. 2 is a side diagrammatic view of an exemplary extraction system of the present disclosure including an extraction device;

FIG. 3 is a side diagrammatic view of an exemplary extraction system of the present disclosure including an extraction device;

FIG. 4 is a side diagrammatic view of an exemplary extraction system of the present disclosure including an extraction device;

FIG. 5 is a side diagrammatic view of an exemplary extraction system of the present disclosure including an extraction device; and

FIG. 6 is a side diagrammatic view of an exemplary extraction system of the present disclosure including an extraction device.

### DETAILED DESCRIPTION

Various terms relating to the systems, methods and other aspects of the present disclosure are used throughout the specification and claims. Such terms are to be given their ordinary meaning in the art unless otherwise indicated. Other specifically defined terms are to be construed in a manner consistent with the definition provided herein.

As used in this specification and the appended claims, the singular forms “a,” “an,” and “the” include plural referents unless the content clearly dictates otherwise.

The term “one or more” as used herein is defined as any whole integer greater than the number 1, e.g., 2, 3, 4, 5 or more. The term “plurality” as used herein is defined as any amount or number greater or more than 1. In some embodiments, the term “plurality” means 2, 3, 4, 5, 6 or more.

The terms “left” or “right” are used herein as a matter of mere convenience, and are determined by standing at the rear of the machine facing in its normal direction of travel. Likewise, “forward” and “rearward” are determined by the normal direction of travel. “Upward” and “downward” orientations are relative to the ground or operating surface as are any references to “horizontal” or “vertical” planes.

The term “about” or “approximately” as used herein when referring to a measurable value such as an amount, a temporal duration, and the like, is meant to encompass variations of ±20%, ±10%, ±5%, ±1%, ±0.5%, ±0.4%, ±0.3%, ±0.2%, ±0.1%, ±0.09%, ±0.08%, ±0.07%, ±0.06%, ±0.05%, ±0.04%, ±0.03%, ±0.02% or ±0.01% from the specified value, as such variations are appropriate to use the disclosed devices or systems.

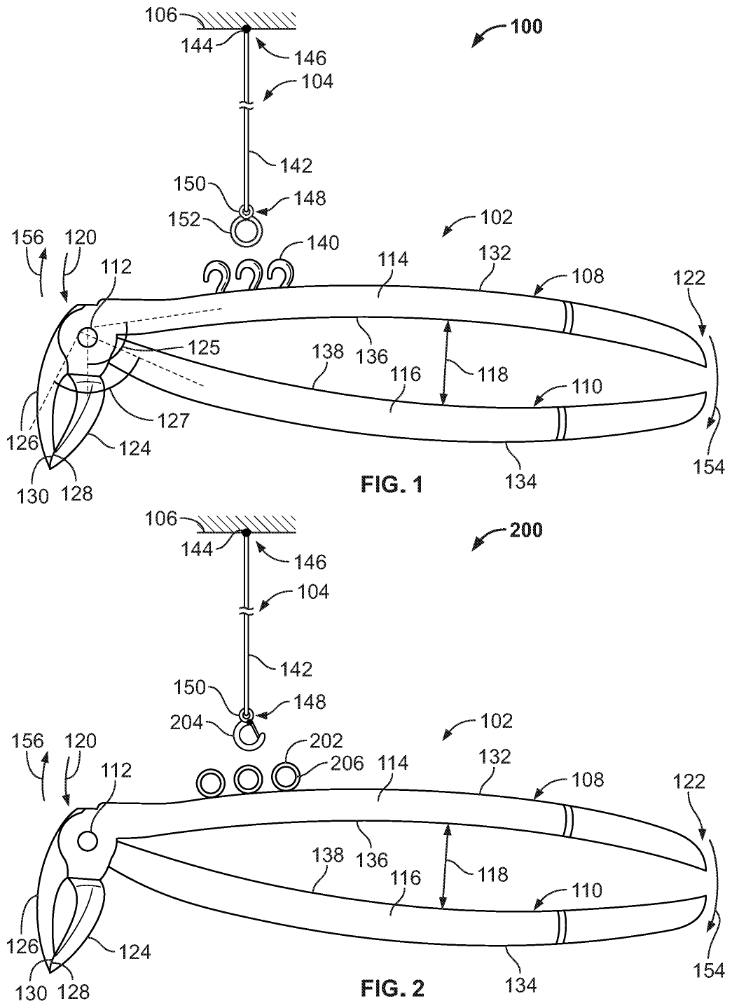

FIG. 1 is a side diagrammatic view of an exemplary extraction system 100 (hereinafter “system 100”) of the present disclosure. The system 100 includes an extraction device 102 and a fixation assembly 104 for detachably securing the extraction device 102 to a support structure 106. In some embodiments, the extraction device 102 can be in the form of forceps fabricated from, e.g., stainless steel, surgical steel, or the like. The extraction device 102 can include a first body half 108 and a second body half 110 hingedly coupled to each other at a hinge 112. The first body half 108 includes an elongated section forming a first handle half 114 (e.g., a first handle) of the extraction device 102, and the second body half 110 includes an elongated section forming a second handle half 116 (e.g., a second handle) of the extraction device 102.

The first and second handle halves 114, 116 can define complementary and opposing curvatures such that the distance 118 between the first and second handle halves 114, 116 is zero at the hinge 112 (e.g., the proximal end 120), gradually increases towards the midpoint between the proximal and distal ends 120, 122, and decreases again at the distal end 122. When oriented in the upright position shown in FIG. 1, the first handle half 114 forms the upper or top section of the grip to be used by the dentist during manipulation of the extraction device 102 during extraction of a structure (such as a tooth, crown, post, or the like), and the second handle half 116 forms the lower or bottom section of the grip to be used by the dentist. Specifically, in combination, the first and second handle halves 114, 116 form the grip for manipulation of the extraction device 102 between an open and closed position.

In some embodiments, the length of the first and second handle halves 114, 116 can be longer than handles of traditional extraction devices to allow for the manipulation and/or pivoting discussed in greater detail below. The longer length of the first and second handle halves 114, 116 as compared to handles of traditional extraction devices also provides for a greater lever arm for use of the extraction device 102. For example, in some embodiments, the overall length of the first and second handle halves 114, 116 as measured between the proximal and distal ends 120, 122 can be about, e.g., 6-16 inches, 7-16 inches, 8-15 inches, 9-14 inches, 10-13 inches, 11-12 inches, 6-12 inches, 6 inches, 7 inches, 8 inches, 9 inches, 10 inches, 11 inches, 12 inches, 13 inches, 14 inches, 15 inches, 16 inches, or the like. The length can be measured between the hinge 112 and the distal ends 120 of the handle halves 114, 116. The length of the handle halves 114, 116 is longer than traditional handles for extraction devices to provide greater mobility and pivoting of the extraction device 102 after anchoring, as will be discussed below.

The extraction device 102 includes a first curved extension 124 extending at an angle 125 from the proximal end 120 of the first handle half 114, and a second curved extension 126 extending at an angle 127 from the proximal end 120 of the second handle half 116. In some embodiments, the angle 125, 127 can be about, e.g., 45-90 degrees, 55-90 degrees, 65-90 degrees, 75-90 degrees, 85-90 degrees, 45-100 degrees, 45-110 degrees, 45-120 degrees, 45 degrees, 55 degrees, 65 degrees, 75 degrees, 85 degrees, 90 degrees, 95 degrees, 100 degrees, 105 degrees, 110 degrees, 115 degrees, 120 degrees, 125 degrees, or the like. The first and second curved extensions 124, 126 can curve towards each other such that distal ends 128, 130 of the respective first and second curved extensions 124, 126 can be positioned against each other. The first and second curved extensions 124, 126 in combination form a beak section of the extraction device 102 configured to be positioned at least partially around or against a tooth to be extracted, and configured to grip the tooth during the extraction process. It should be understood that the configuration of the beak section of the extraction device 102 can be different depending on the type of task to be performed with the extraction device 102, e.g., tooth extraction, crown extraction, post extraction, or the like.

Each of the first and second handle halves 114, 116 can include an outer surface 132, 134 and an inner surface 136, 138, with the inner surfaces 136, 138 facing each other. The outer surface 132 of the first handle half 114 includes one or more anchors 140 (e.g., male connectors) extending upwardly therefrom. The anchors 140 can extend substantially perpendicularly from the outer surface 132 (e.g., away from the first and second handle halves 114, 116). In some embodiments, the anchor 140 can be in the form of a steel hook, as shown in FIG. 1. In some embodiments, the extraction device 102 can include two or more adjacently positioned anchors 140 to allow selection by the user based on the desired pivot point of the extraction device 102 (e.g., based on the tooth to be extracted and/or the position of the patient). The adjacently positioned anchors 140 can be spaced from each other along the proximal end 120 to distal end 122 direction. The anchor 140 can be positioned offset from yet closer to the proximal end 120 of the extraction device 102 than the distal end 122 of the extraction device 102. In some embodiments, the anchor 140 can be positioned about, e.g., 1-4 inches, 1-3 inches, 1-2 inches, 2-3 inches, 2-4 inches, 1 inch, 2 inches, 3 inches, 4 inches, or the like, from the hinge 112.

The fixation assembly 104 of the system 100 includes an elongated fixation element 142 secured to the support structure 106. Although illustrated as secured to a support structure 106 in the form of a ceiling, in some embodiments, the support structure 106 can be, e.g., a vertically disposed or angled wall extending relative to the ceiling, a post or wall fixed to the ceiling and extending downwardly, a post fixed to the ceiling and adjustable in length and/or position, the floor, or the like. The fixation element 142 can therefore be attached to any support structure 106 capable of providing the desired pivot point and/or angle for tooth extraction. The support structure 106 is a structure disposed at a distance from the extraction device 102 and the patient.

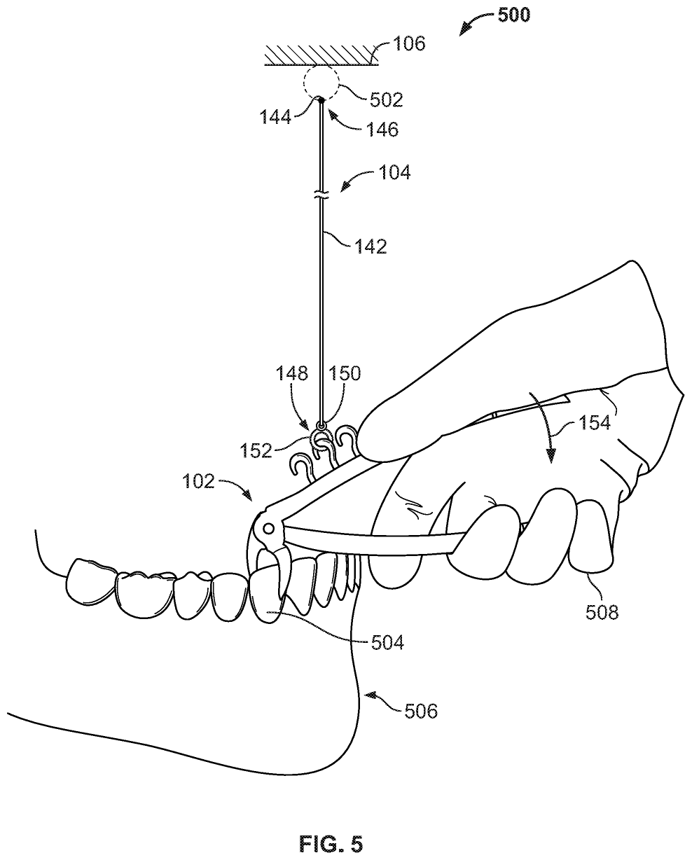

In some embodiments, the fixation element 142 can be in the form of, e.g., a steel cable, a steel chain, vinyl-coated steel wire rope or cable, combinations thereof, or the like. In some embodiments, a distal end 146 of the fixation element 142 can be mounted directly to the support structure 106 at a mounting point 144 without providing adjustment in overall length of the fixation element 142. The position of the mounting point 144 of the fixation element 142 can be adjusted relative to the support structure 106 based on the desired user position. In some embodiments, the distal end 146 of the fixation element 142 can be mounted to a mechanism (e.g., an adjustable reel, or the like) to allow for adjustment in overall length of the fixation element 142 (see, e.g., FIG. 5). The length adjustment of the fixation element 142 can be controlled by, e.g., manually controlling the mechanism, actuating a control on a dentist chair or associated structure, actuating a control located on the floor, actuating a control located on a wall, or the like.

The proximal end 148 of the fixation element 142 can include one or more anchors 150, 152 (e.g., female connectors) complementary to the anchors 140 of the extraction device 102. In some embodiments, the one or more anchors 150, 152 can be in the form of a steel loop. In operation, the patient can sit and/or recline in a dentist chair in preparation for the tooth extraction procedure. The fixation element 142 can be lowered or extended from the support structure 106 until the anchor 152 of the fixation element 142 can be detachably engaged with the anchor 140 of the extraction device 102. The length of the fixation element 142 can be further adjusted such that the extraction device 102 can be positioned in the desired location relative to the tooth of the patient to be extracted. The mechanism associated with the fixation element 142 can be used to lock the length of the fixation element 142 to prevent undesired extension.

The beak (e.g., extensions 124, 126) of the extraction device 102 can be positioned around the tooth to be extracted, and the extraction device 102 can be pivoted about the pivot point created by engagement between the anchors 140, 152 in the direction represented by arrow 154. The pivot point at the anchor 140, 152 engagement creates a fulcrum effect that generates an upward pulling force (represented by arrow 156) at the proximal end 120 of the extraction device 102 and, specifically, at the extensions 124, 126, thereby assisting in extracting the tooth from the patient. Engagement between the anchor 140 of the extraction device 102 and the anchor 152 of the fixation assembly 104 allows for pivoting of the extraction device 102 without relying on positioning of the extraction device 102 against a healthy tooth of the patient.

FIG. 2 is a side diagrammatic view of an exemplary extraction system 200 (hereinafter “system 200”) of the present disclosure. The system 200 can be substantially similar to the system 100, except for the distinctions noted here. Therefore, like reference numbers are used to refer to like structures. In particular, rather than including an anchor 140 in the form of a hook, the extraction device 102 of FIG. 2 includes an anchor 202 in the form of one or more steel loops. The anchor 202 can be positioned such that a central axis passing through the opening 206 in the loops is oriented transversely to the sides of the extraction device 102. Rather than including an anchor 152 in the form of a loop, the system 200 includes an anchor 204 in the form of a spring-loaded clip (e.g., a carabiner, a lock ring, a gate snap, a hook, or the like). In some embodiments, the anchor 204 can be in the form of a hook without a spring-loaded fastener. The anchor 204 can be selectively engaged and disengaged relative to the desired anchor 202.

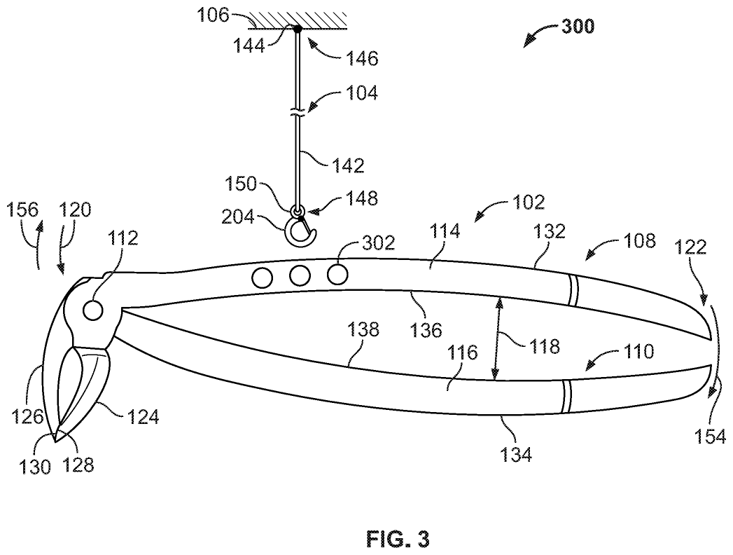

FIG. 3 is a side diagrammatic view of an exemplary extraction system 300 (hereinafter “system 300”) of the present disclosure. The system 300 can be substantially similar to the systems 100, 200, except for the distinctions noted here. Therefore, like reference numbers are used to refer to like structures. In particular, rather than including anchors 140, 202 in the form of hooks or loops, the extraction device 102 can include one or more anchors 302 in the form of holes formed in the first handle half 114. The central axis of the holes can extend substantially transversely relative to the sides of the extraction device 102. The anchor 204 can be selective engaged and disengaged relative to the desired anchor 302.

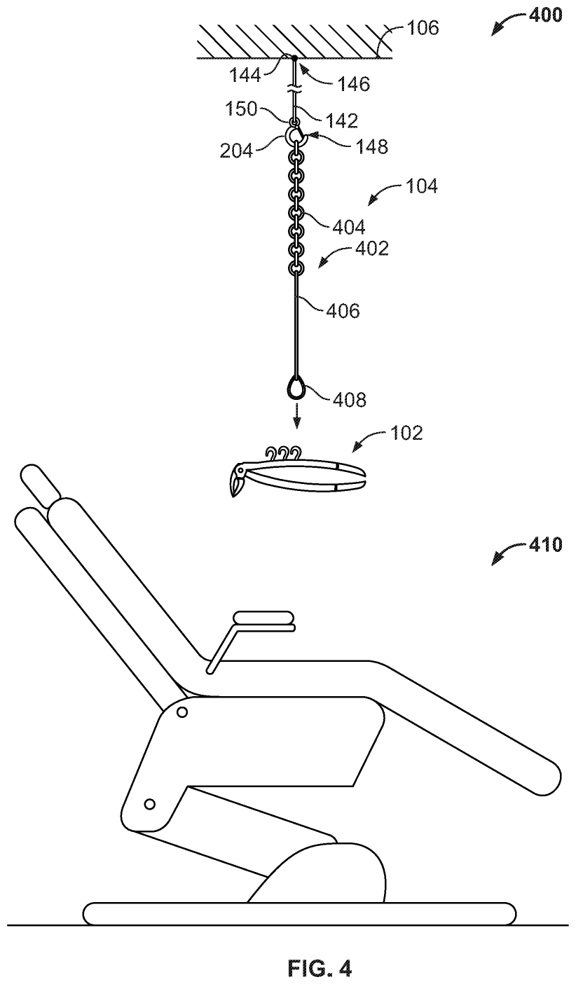

FIG. 4 is a side diagrammatic view of an exemplary extraction system 400 (hereinafter “system 400”) of the present disclosure. The system 400 can be substantially similar to the systems 100, 200, except for the distinctions noted here. Therefore, like reference numbers are used to refer to like structures. In particular, the fixation assembly 104 (in addition to the fixation element 142) can include an extension element 402 attachable to the proximal end 148 of the fixation element 142. In some embodiments, the extension element 402 can include a chain section 404 with a plurality of chain links (e.g., 10-20 chain links, 12-18 chain links, 14-16 chain links, or the like). One end of the chain section 404 can be coupled to a cable section 406. One end of the cable section 406 is attached to the chain section 404, and the opposing end of the cable section 406 can include an anchor 408 (e.g., a steel loop, or the like).

In the embodiment of FIG. 4, the fixation element 142 can have a fixed overall length (e.g., not adjustable), and the chain section 404 of the extension element 402 can be detachably coupled to the anchor 204. The anchor 408 (not the anchor 204) can thereby be detachably engaged with the anchor 140 of the extraction device 102. If adjustment in overall length of the fixation assembly 104 is desired, the chain link of the chain section 404 engaged with the anchor 204 can be adjusted manually by the user until the desired length is achieved. In some embodiments, the chain section 404 can provide additional length adjustment to the fixation assembly 104 in combination with adjustability of the length of the fixation element 142. The position of the extraction device 102 relative to the patient sitting in the dentist chair 410 can thereby be adjusted as needed depending on, e.g., the position of the patient, the tooth to be extracted, the desired fulcrum position and/or force, combinations thereof, or the like.

FIG. 5 is a side diagrammatic view of an exemplary extraction system 500 (hereinafter “system 500”) of the present disclosure. The system 500 can be substantially similar to the system 100, except for the distinctions noted here. Therefore, like reference numbers are used to refer to like structures. As described with respect to FIG. 1, the fixation assembly 104 can include and/or be coupled to a length adjustment mechanism 502 (e.g., an adjustable reel) to allow for adjustment of the overall length of the fixation element 142. Although shown as attached to the support structure 106 (e.g., the ceiling), it should be understood that the length adjustment mechanism 502 can be disposed at a midpoint of the fixation element 142 and/or the proximal end 148 of the fixation element 142. The length adjustment mechanism 502 can be controlled by, e.g., manually controlling rotation of the mechanism, actuating a control on a dentist chair or associated structure, actuating a control located on the floor, actuating a control located on a wall, or the like, to adjust the overall length of the fixation element 142.

FIG. 5 shows the extraction device 102 positioned relative to a tooth 504 of a patient 506 to be extracted by the dentist 508. Although shown as being used for extraction of the tooth 504, it should be understood that the extraction device 102 can be substantially similarly used for extraction of a crown, post, or the like. FIG. 5 shows the extraction device 102 in a position for extraction of the tooth 504 at a lower jaw of the patient 506. A downward force can be placed by the dentist 508 on the extraction device 102 to tighten the fixation assembly 104, the extraction device 102 can be positioned around the tooth 504 to be extracted, and the extraction device 102 can be pivoted at the pivot point defined by the connection between the anchors 140, 152 in the direction represented by arrow 154 to extract the tooth 504. The connection and support provided to the extraction device 102 by the fixation assembly 104 ensures that the extraction device 102 is not placed against healthy teeth surrounding the tooth 504 during the extraction process, thereby maintaining the healthy structure of such teeth.

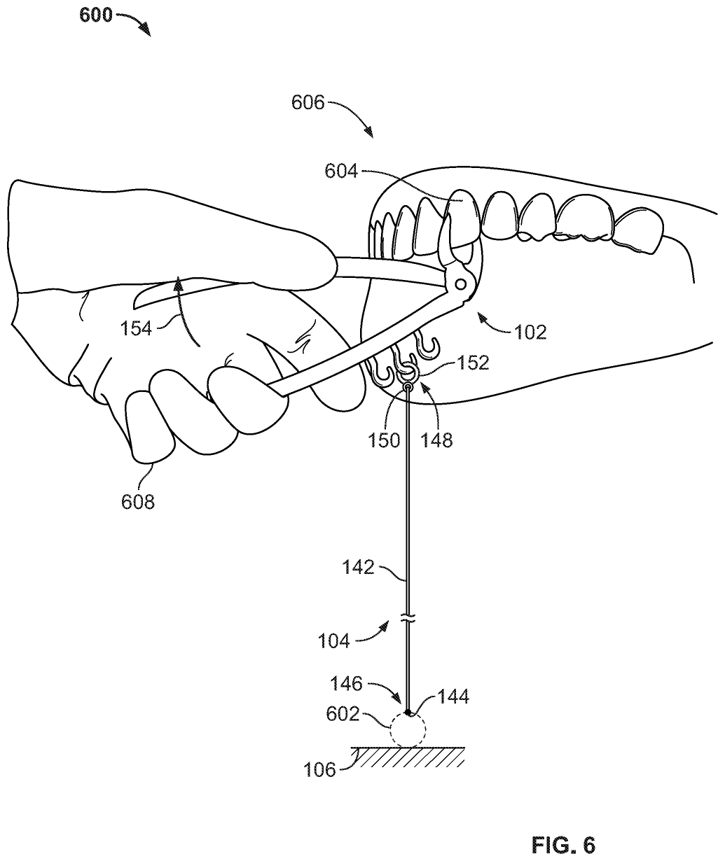

FIG. 6 shows the extraction device 102 positioned relative to the tooth 504 of the patient 506 to be extracted by the dentist 508. FIG. 6 shows the extraction device 102 in a position for extraction of the tooth 504 at an upper jaw of the patient 506. The fixation assembly 104 can be secured to a support structure 106 in the form of the floor. An upward force can be placed by the dentist 508 on the extraction device 102 to tighten the fixation assembly 104, the extraction device 102 can be positioned around the tooth 504 to be extracted, and the extraction device 102 can be pivoted at the pivot point defined by the connection between the anchors 140, 152 in the direction represented by arrow 154 to extract the tooth 504. The connection and support provided to the extraction device 102 by the fixation assembly 104 ensures that the extraction device 102 is not placed against healthy teeth surrounding the tooth 504 during the extraction process, thereby maintaining the healthy structure of such teeth.

While exemplary embodiments have been described herein, it is expressly noted that these embodiments should not be construed as limiting, but rather that additions and modifications to what is expressly described herein also are included within the scope of the present disclosure. Moreover, it is to be understood that the features of the various embodiments described herein are not mutually exclusive and can exist in various combinations and permutations, even if such combinations or permutations are not made express herein, without departing from the spirit and scope of the present disclosure.

1. An extraction device, comprising:
a first body half including a first handle with an outer surface and an inner surface;
a second body half hingedly coupled to the first body half, the second body half including a second handle with an outer surface and an inner surface, the outer surface of the first handle facing away from the outer surface of the second handle, and the inner surfaces of the first and second handles facing each other; and
an anchor extending from the outer surface of the first handle or formed in the first handle.

2. The extraction device of claim 1, wherein the first body half includes a first curved extension extending at an angle from a proximal end of the first body half, the first curved extension forming a first half of a beak section of the extraction device.

3. The extraction device of claim 2, wherein the second body half includes a second curved extension extending at an angle from a proximal end of the second body half, the second curved extension forming a second half of the beak section of the extraction device.

4. The extraction device of claim 1, wherein the first and second body halves include proximal and distal ends, and wherein the first and second body halves are hingedly coupled together at or near the proximal ends.

5. The extraction device of claim 1, wherein the anchor is configured to engage with a corresponding anchor of a fixation assembly coupled to a support structure, engagement between the anchor of the extraction device and the corresponding anchor of the fixation assembly creating a pivot point at the anchor of the extraction device.

6. The extraction device of claim 1, wherein the anchor defines a hook configuration extending from the outer surface of the first handle.

7. The extraction device of claim 6, wherein the anchor includes three anchors each defining the hook configuration and spaced relative to each other along the outer surface of the first handle.

8. The extraction device of claim 1, wherein the anchor defines a loop configuration extending from the outer surface of the first handle.

9. The extraction device of claim 1, wherein the anchor defines a hole formed in the first handle and extending transversely relative to sides of the first handle.

10. An extraction system, comprising:
an extraction device including (i) a first body half including a first handle with an outer surface and an inner surface, (ii) a second body half hingedly coupled to the first body half, the second body half including a second handle with an outer surface and an inner surface, the outer surface of the first handle facing away from the outer surface of the second handle, and the inner surfaces of the first and second handles facing each other, and (iii) an anchor extending from the outer surface of the first handle or formed in the first handle; and
a fixation assembly including a proximal end and a distal end, the proximal end of the fixation assembly configured to be engaged with the anchor of the extraction device to allow for pivoting of the extraction device.

11. The extraction system of claim 10, wherein the distal end of the fixation assembly is configured to be coupled to a support structure.

12. The extraction system of claim 11, wherein the support structure is at least one of a ceiling, a wall, or a floor.

13. The extraction system of claim 11, wherein after engagement of the proximal end of the fixation assembly with the anchor of the extraction device, the extraction device is suspended from the support structure by the fixation assembly.

14. The extraction system of claim 10, wherein the fixation assembly includes an anchor at the proximal end, the anchor of the fixation assembly configured to be detachably engaged with the anchor of the extraction device.

15. The extraction system of claim 14, wherein engagement between the anchor of the fixation assembly and the anchor of the extraction device forms a pivot point about which the extraction device is capable of pivoting.

16. The extraction system of claim 14, wherein the anchor of the fixation assembly is at least one of a loop or a spring-loaded clip.

17. The extraction system of claim 10, wherein the fixation assembly includes a length adjustment mechanism controllable to adjust a length of the fixation element.

18. A method of extraction, comprising:
engaging an extraction device with a fixation assembly coupled to a support structure, the extraction device including (i) a first body half including a first handle with an outer surface and an inner surface, (ii) a second body half hingedly coupled to the first body half, the second body half including a second handle with an outer surface and an inner surface, the outer surface of the first handle facing away from the outer surface of the second handle, and the inner surfaces of the first and second handles facing each other, and (iii) an anchor extending from the outer surface of the first handle or formed in the first handle;
gripping at least a portion of a structure to be extracted with the extraction device; and
pivoting the extraction device at a point of engagement with the fixation assembly to create a force for extracting the structure.

19. The method of claim 18, wherein the support structure is at least one of a ceiling, a wall, or a floor.

20. The method of claim 18, wherein engaging the extraction device with the fixation assembly comprises engaging an anchor of the fixation assembly with the anchor of the extraction device to suspend the extraction device from the fixation assembly.
